(19) United States
(12) Patent Application Publication
(10) Pub. No.: US 2019/0337863 A1
(43) Pub. Date: Nov. 7, 2019

(54) ORGANIC NITROGENOUS FERTILIZERS

(71) Applicant: CALIFORNIA ORGANIC FERTILIZERS, INC., Hanford, CA (US)

(72) Inventor: Timothy Stemwedel, Hanford, CA (US)

(21) Appl. No.: 16/402,188

(22) Filed: May 2, 2019

Related U.S. Application Data
(60) Provisional application No. 62/665,941, filed on May 2, 2018.
(60) Provisional application No. 62/678,263, filed on May 30, 2018.

(51) Int. Cl. C05C 3/00; C05F 11/00; C05F 17/00

(52) U.S. Cl. CPC C05C 3/00; C05F 17/0054; C05F 17/0063; C05F 11/00

(57) ABSTRACT

The present invention relates to organic nitrogen fertilizers and methods for producing organic nitrogen fertilizers, including retrieving high concentration organic ammonia from discarded organic material.

### FIELD OF THE INVENTION

The present invention relates to fertilizers comprising organic materials, and more particularly to fertilizer compositions comprising ammonia compounds generated through biological processes and in high concentration.

### DISCUSSION OF THE BACKGROUND

Organic farming is a highly regulated segment of the agricultural industry. Government entities such as the US Department of Agriculture (USDA) and various state agencies have formulated strict rules (e.g., under the Organic Foods Production Act) governing the growing and handling techniques required for products labeled as “organic”. These regulations are generally aimed at maintaining ecological and environmental conditions, and providing healthy foods. The demand for organic foods is rapidly increasing due to environmental stewardship concerns, and consumer preference. Thus, many portions of the agricultural industry have become focused on organic alternatives to conventional methods of production, including using organic pesticides, herbicides, and fertilizers. Regulatory, environmental, and health concerns are primary reasons for using natural or organic products.

As such there is a substantial potential market for fertilizers and other products that comply with the regulations for growing, harvesting or otherwise processing and/or obtaining organic food products. However, the existing chemical fertilizers are generally prohibited in organic farming, composts and manures are commonly used as fertilizers. Composts and manures are often insufficient to generate desired crop yield, and thus supplemental nitrogen is often needed in organic cropping systems. The industry has faced difficulties in finding economically efficient and effective organic chemical agents and natural materials, including nitrogen fertilizers that can be used in the industry. Thus, the agricultural industry faces significant challenges in productivity and efficiency in the area of organic farming.

There continues to be a particular need in organic farming for more effective fertilizers to replace compost and other nitrogen sources that provide insufficient nitrogen. Finding economical and efficient alternatives to existing sources of nitrogen for use in organic farming has thus far been largely fruitless. Therefore, improved and efficient compositions of naturally produced nitrogenous compounds are needed.

### SUMMARY OF THE INVENTION

The present invention provides organic fertilizers compositions and methods for making the same. The organic fertilizers of the present invention comprise nitrogen compounds extracted from natural sources of nitrogenous compounds, without chemical reactions. The natural sources of nitrogenous compounds may be generated by food processing plants, bio-digesters, rendering plants, dairies, and other sources. The nitrogen compounds may also be derived from rich organic liquid materials, such as wastewater sludge, slurry from slaughter houses, fowl manures, etc. The nitrogen is extracted from the organic material without the use of chemical reactions, and thus provides an organic source of nitrogen compounds (e.g., particularly aqueous ammonia) that can be used in fertilizer compositions for use in organic farming.

The invention provides a liquid or solid organic fertilizers for organic agriculture obtained by extracting nitrogenous compounds from discarded organic materials. The fertilizer composition may include the organically derived nitrogenous compounds at a concentration in a range of about 3% to about 30% by weight.

The fertilizer composition may further include other ingredients, such as organic acids, humic acids, and various nutrients. Nitrogen may be comprised in ammonia and/or other nitrogenous compounds that can be added to the organic fertilizer compositions as an organic input material (OIM).

In some embodiments, this invention provides a method for manufacturing a liquid or nitrogen fertilizer from discarded organic material, comprising the steps of i) collecting nitrogen-rich organic material from a facility, such as a food processing plants, rendering plants, dairies, and other sources;; ii) conducting a biodigestion of the discarded organic waste material; iii) separating the liquid portion (biodigestion effluent) of the biodigested organic material; iv) heating the biodigestion effluent to facilitate removal of the ammonia and other nitrogenous compounds from the biodigestion effluent; v) passing the heated effluent through a steam stripping column to remove contaminants and produce a; vi) collecting the steam/ammonia solution; vii) and condensing the exhaust gas to form a liquid extract.

In some embodiments, this invention provides a method for manufacturing a liquid nitrogen fertilizer from discarded organic material, comprising the steps of i) heating and/or raising the pH of ammonia rich effluent to degas contaminants from the effluent; ii) volatilizing the ammonia using steam and running the ammonia through a stripping column to extract the ammonia; iii) concentrating the extracted ammonia in a liquid solution, and iv) combining said liquid solution into a liquid fertilizer composition.

The discarded organic material used for the extraction process may be from various organic substrate sources, including plant biomass, manure, other animal waste, municipal and food wastes. The discarded organic material must be processed through a non-chemical microbe-mediated digestion process to produce a liquid byproduct rich in ammonia and ammonium compounds. Such organic materials may be utilized the extraction process disclosed herein. The digestion process may be an anaerobic digestion process that produces ammonia and ammonium compounds as byproducts.

In some embodiments, exhaust gas from processing organic materials can be used as the starting material from which the nitrogenous compounds are extracted. Such exhaust gas may be generated by food processing plants, bio-digestors, rendering plants, dairies, and other sources, and then captured for use in the ammonia extraction process disclosed herein. Ammonia-rich exhaust gases may be directly introduced into the steam stripping process described below, without the biodigestion and effluent separation processes.

In order to maximize the ammonia and ammonium compound production in the biodigestion process, a co-digestion process that utilizes a balance of substrates may be used. The co-digestion may include a major substrate available in large amounts (e.g. manure or sewage sludge) and additional minor co-substrates present in smaller amounts for purposes of balancing the chemistry of co-digestion to facilitate ammonia and ammonium compounds in the biodigestion process. Co-digestion improves nutrient balance and digestion, equalization of solids by dilution, biogas production, and increases the potential for production of ammonia and ammonium compounds produced by natural means without chemical reactions while producing higher yields of ammonia and ammonium compounds.

Anaerobic bacteria may be used in the biodigestion process. Biogas production can be limited to the nutrient and fatty acid content of the digestion medium. In biodigestion, high fermentation rates from proteins from animal derived co-substrates result in the formation of ammonia. Thus, biowastes high in proteins (e.g., slaughter house wastes) are ideal for producing a substrate for the ammonia extraction process disclosed herein. However, the production of large concentrations of ammonia in the biodigestion process can raise pH and inhibit other desirable digestion processes, such as contemporaneous methanogenesis. Thus, co-digestion with other substrates, such as manure and nutrient supplements that supply sodium, calcium, magnesium, and trace amounts of nickel, cobalt, molybdenum, and/or selenium can counter-act the effects of increased ammonia and hydrogen sulfide and other inhibitory chemical products of the anaerobic digestion. An alternative biodigestion substrate that is able to produce high levels of ammonia is a combination of manure, plant biomass, general municipal sewage, and other low-protein materials in combination with non-synthetic high-protein supplements such as blood meal, alfalfa, corn, and sweet clover. Such proteinaceous co-substrates provide nutrients missing from biodigestion of low-protein materials and help to prevent inhibiting substances from affecting methanogenesis.

Blood meal is a high protein, low fat animal product that provides high levels of nitrogen for ammonia production and low fat content, reducing the amount of fatty acids and other byproducts that create inefficiencies in the biodigestion process. Sweet clover is a nutrient rich and widely available legume that contains 15% protein. Alfalfa is also highly digestible, readily providing the nutrients therein for the anaerobes in the biodigestion mixture. Thus, blood meal and/or sweet clover (and other high nitrogen organic matter, such as sweet clover and corn) can be loaded into the digesters along with the biological materials to create a high-nitrogen effluent. The nitrogen in the effluent may be predominantly in the form of ammonia. An exemplary substrate and additive for anaerobic digestion can comprise blood meal, alfalfa, corn, sweet clover, and/or a discarded organic material (such as manure or municipal waste).

The liquid effluent created by the biodigestion process may subsequently be used in the ammonia extraction process of the present invention. The method of extracting ammonia and other ammonium compounds from the effluent includes optimizing the chemical condition of the effluent by increasing the temperature and/or pH of the effluent to drive the chemical equilibrium of ammonium bicarbonate and free ammonia in the effluent toward the release of more free ammonia, degassing of the effluent to remove carbon dioxide therefrom, and extracting NH₃ and ammonium compounds from the effluent. The ammonia in the optimized effluent may be extracted through a steam stripping process using a packing column through which the optimized effluent may be passed in the presence of steam. Ammonia may also be captured from the gas produced through the heating of the effluent to degas CO₂. The gas produced from the heating process may include significant amounts of gaseous NH₃. The resulting ammonia extract is produced without chemical reactions that would disqualify it from use on organic crops and thus it provides a rich and economic source of nitrogen for organic fertilizers.

In the extraction process, effluent from the biodigestion process may be first heated to raise the temperature of the liquid to degas carbon dioxide from the effluent. The effluent may also be treated with a basic chemical agent to raise the pH of the waste water. In some examples, the basic agent may be sodium hydroxide, which may be added in sufficient amounts to raise the pH of the waste water to a pH in the range of about 8 to about 11. In other embodiments, other basic agents may be used, such as lime, calcium hydroxide, and other bases. The effluent may be heated to a temperature in a range from about 120° F. to about 150° F. to properly drive CO₂ out of the effluent. The heating process may remove up to about 90% of the CO₂ from the effluent, thereby pushing the chemical equilibrium of ammonium bicarbonate and ammonia significantly toward free ammonia, thereby facilitating an extraction of a greater quantity of ammonia from the effluent. Ammonia remains in the effluent as bound ammonium compounds and ammonia. The evaporated ammonia may be recaptured from the evolved gas by a capture process discussed below. This process may also result in the volatilization of some ammonia, which may be recaptured form the evolved gas using a process discussed below.

The optimized effluent may then be transferred to a steam stripping apparatus that may include a packed column that contains a conventional, high surface area packing material as a stationary phase. Steam may be provided at the bottom of the column to maintain a high temperature of the effluent introduced into the column and as a collection medium for the volatilized ammonia. The high surface area packing material may allow for high surface area interaction between the steam and the effluent. This has two benefits: (1) it keeps the temperature of the effluent high to volatilize the ammonia present in the effluent, and (2) it allows the steam passing through the column to mix thoroughly with the effluent and collect as much of the heated ammonia as possible. The steam/ammonia mixture may rise through the column and then be transferred to a condenser for cooling and collection.

In some embodiments, the gas produced during the degassing process may be mixed with the steam/ammonia mixture in an upper portion of a packed column to extract the ammonia therein, and they may together be transferred to a condenser for cooling and collection of the ammonia. In other embodiments, the degassed carbon dioxide and ammonia from the heating process may be put through a first packed column and mixed with fluid (e.g., cool water or other fluid sprayed into the column) to cool the evolved carbon dioxide and ammonia mixture such that the ammonia can be dissolved in the effluent, but the less soluble carbon dioxide remains separate from the solution and escapes from the column as a gas. The resulting effluent from the first packed column may then be transferred to a second packed column, in which the steam stripping process is performed.

The ammonia produced by this process is an organic ammonium hydroxide solution that is usable in organic farming. The ammonia is produced at a concentration in a range of about 15-30% w/w ammonia solution. The organic ammonia solution may be used to create fertilizer compositions that are compliant with the Organic Foods Production Act of 1990, USDA Organic Regulations, (generally referred to as the National Organic Program or NOP) and other agency standards for use in organic farming and can be used in organic farming operations. In some embodiments, the ammonium hydroxide composition may be mixed with other plant and soil nutrient compounds that are compatible with organic farming to create a nitrogen-rich organic fertilizer composition.

In some embodiments, and without limitation, a fertilizer composition may include a liquid composition that includes about 3% to about 30% ammonia w/w (e.g., 10% w/w to about 25% w/w, or any value or range of values therein), and/or one or more additional ingredients. The fertilizers may further include organic acids that may serve to balance the pH effects of the concentrated ammonia in the fertilizer. The pH may be maintained in a range around neutral pH, such as between about pH 6 and pH 8 (e.g., from about pH 6.5 to about pH 7.5). To balance the pH of the liquid fertilizer, the liquid fertilizer may include one or more organic acids.

The organic fertilizers may include one or more weak organic acids or salts thereof (e.g., polyprotic organic acids or salts thereof), such as citric acid, malic acid, fumaric acid, salts of such organic acids, and combinations thereof. Other simpler organic acids, such as acetic acid salts of such organic acids may be used as well. The organic acids must be from organically-compliant sources (e.g., NOP compliant). Citric acid may be preferred due to its tri-protic chemistry and superior buffering capabilities. The organic acid(s) may be present in a concentration in the liquid fertilizer in a range of about 15% by weight to about 50% by weight, depending on the concentration of ammonia in the liquid fertilizer. For example, the concentration of citric acid in the liquid fertilizer by weight may be about twice the amount of ammonia present in the solution by weight. Simpler monoprotic acids may be present in higher concentrations, due to their lower buffering capacity.

The organic fertilizers of the present invention may also include humic acids, which help with nitrogen fixation in the organic fertilizers. Liquid ammonia fertilizers suffer from nitrogen loss through the evaporation or other pathways of loss. Planting soils are typically acidic to optimize conditions for the growth of plants, which exhibit optimal germination and growth in a pH range of about pH 5.0 to about pH 7.0. The acidic pH of the soil can increase ammonia volatilization. This particularly significant where the fertilizer composition has a relatively high nitrogen concentration (e.g., greater than 10% w/w), since the higher concentration results in a higher rate of volatilization. Humic acids are able to retain NH₄ as well as aid in NH₃ ammonia volatilization reduction. Humic acids have high cation exchange capacity (CEC) that allows it to retain soil cations and can significantly reduce NH₃ volatilization upon addition to an acidic soil (e.g., through the addition of peat). The addition of humic acids to the organic NH₃ fertilizer of the present invention significantly reduces NH₃ volatilization and lead to effective accumulation of NH₄ in the planting soil, despite having an acidic pH (e.g., about pH 5.5 to about 7.0). The humic acids may provide the additional benefit of providing short carbon-chain molecules

Humic acids may be added included in the organic fertilizer composition of the present invention in a concentration in a range of about 3% w/w to about 8% w/w. The amount of humic acids included in the organic fertilizer may vary with the concentration of ammonia provided therein. For example, in compositions comprising about 10% to about 15% NH₃ w/w, the fertilizer composition may include about 3% to about 4% w/w of humic acids. In compositions comprising about 15% to about 25% organic NH₃ w/w, the fertilizer composition may include about 5% to about 8% w/w of humic acids.

The organic fertilizer composition of the present invention may also include additional components routinely used in the art, for example, humectants, adjuvants, antioxidants, stabilizers, plant macronutrients, plant micronutrients, and combinations thereof.

The organic fertilizer composition of the present invention may also include a solid fertilizer composition comprising about 3% to about 30% ammonia w/w (e.g., 10% w/w to about 25% w/w, or any value or range of values therein), and/or one or more additional ingredients. The fertilizers may further include organic acids that may serve to balance the pH effects of the concentrated ammonia in the fertilizer. The pH may be maintained in a range around neutral pH, such as between about pH 6 and pH 8 (e.g., from about pH 6.5 to about pH 7.5). The solid fertilizer composition may additionally include humectants, adjuvants, antioxidants, stabilizers, plant macronutrients, plant micronutrients, and combinations thereof. The fertilizer composition may include further nutrients, such as gypsum as a calcium sulfate source, and dolomitic lime as a calcium carbonate and magnesium carbonate source.

It is an objective of the present invention to provide improved organic fertilizers that include an organic nitrogen source that complies with regulatory agencies, such as the FDA and NOP.

It is a further objective of the present invention to provide improved methods for producing concentrated ammonia from a natural source without chemical reactions.

It is a further objective of the present invention to provide improved organic fertilizer compositions having a high concentration of naturally derived ammonia. Existing OIM products are low in the ammonia form of nitrogen. Increased levels of nitrogen will result in a greater availability of ammonia and nitrate nitrogen. The ammonia may then be converted to nitrates by nitrifying bacteria in the soil.

In one aspect, the present invention relates to a liquid organic nitrogenous fertilizer composition, comprising an aqueous solution of a biologically produced ammonia in a concentration of about 3% to about 25%; and an organic acid in a concentration of about 6% to about 50%. The composition may further include humic acids as a chelation agent for the ammonia. The humic acids may be present in a concentration of about 3% to about 8%. The organically produced ammonia may be present in a concentration of about 10% w/w to about 20% w/w. The organic acid may be present in a concentration of about 20% w/w to about 40% w/w. The organic acid may be a triprotic acid. The organic acid may be citric acid.

In another aspect, the present invention relates to a liquid organic nitrogenous fertilizer composition, comprising an aqueous solution including a biologically produced ammonia in a concentration of about 3% to about 25%. The composition may further include humic acids as a chelation agent for the ammonia. The humic acids may be present in a concentration of about 3% to about 8%. The organically produced ammonia may be present in a concentration of about 10% w/w to about 20% w/w. The organic acid may be present in a concentration of about 20% w/w to about 40% w/w. The composition may further comprise an organic acid. The organic acid may be a triprotic acid. The organic acid may be citric acid.

In a further aspect, the present invention relates to a method of producing organic ammonia, comprising heating an organic waste material in an anaerobic digester device to drive a biological anaerobic digestion of the organic waste material and yield a digested organic waste composition; separating solid portions of the organic waste composition from an effluent of the digested organic waste composition; heating said effluent to evolve CO₂-laden gas from the effluent; transferring the heated effluent to a steam stripping apparatus to extract NH₃ from said heated effluent in a steam/NH₃ solution; and condensing the steam/NH₃ solution to yield an aqueous NH₃ product derived from effluent without chemical reactions. The step of heating said effluent drives the chemical equilibrium of ammonium bicarbonate toward the production of NH₃ and CO₂. The method may further comprise adding a basic chemical agent to the effluent before or during the step of heating said effluent to increase the pH of the effluent. The method may further comprise the step of transferring the CO₂-laden gas to a packed column to cool the CO₂-laden gas and dissolve NH₃ present in the gas in a cooling fluid. The method may further comprise transferring the cooling fluid and NH₃ dissolved therein to the steam stripping process to extract the dissolved NH₃. The aqueous NH₃ produced by the foregoing method may be included in an aqueous liquid organic nitrogenous fertilizer composition, along with an organic acid in a concentration of about 6% to about 50%. The fertilizer composition may further comprise humic acids as a chelation agent for the ammonia. The humic acids may be present in a concentration of about 3% to about 8%. The organically produced ammonia may be present in a concentration of about 10% w/w to about 20% w/w. The organic acid may be present in a concentration of about 20% w/w to about 40% w/w. The composition may further comprise an organic acid. The organic acid may be a triprotic acid. The organic acid may be citric acid.

In a further aspect, the present invention relates to a method of producing organic ammonia, comprising heating a nitrogen-rich effluent to evolve CO₂-laden gas from the effluent; transferring the heated effluent to a steam stripping process to extract NH₃ from said heated effluent in a steam/NH₃ solution; and condensing the steam/NH₃ solution to yield an aqueous NH₃ product derived from said effluent without utilizing chemical reactions. The step of heating said effluent drives the chemical equilibrium of ammonium bicarbonate toward the production of NH₃ and CO₂. The method may further comprise adding a basic chemical agent to the effluent before or during the step of heating said effluent to increase the pH of the effluent. The method may further comprise the step of transferring the CO₂-laden gas to a packed column to cool the CO₂-laden gas and dissolve NH₃ present in the gas in a cooling fluid. The method may further comprise transferring the cooling fluid and NH₃ dissolved therein to the steam stripping process to extract the dissolved NH₃. The aqueous NH₃ produced by the foregoing method may be included in an aqueous liquid organic nitrogenous fertilizer composition, along with an organic acid in a concentration of about 6% to about 50%. The fertilizer composition may further comprise humic acids as a chelation agent for the ammonia. The humic acids may be present in a concentration of about 3% to about 8%. The organically produced ammonia may be present in a concentration of about 10% w/w to about 20% w/w. The organic acid may be present in a concentration of about 20% w/w to about 40% w/w. The composition may further comprise an organic acid. The organic acid may be a triprotic acid. The organic acid may be citric acid.

Additional aspects and objects of the invention will be apparent from the detailed descriptions and the claims herein.

### BRIEF DESCRIPTION OF THE DRAWINGS

FIG. 1 shows a flow chart of a process for processing ammonia-laden biodigestion effluent.

FIG. 2 shows an apparatus for processing biodigestion effluent to produce an organically compliant ammonia-rich aqueous fluid.

### DETAILED DESCRIPTION OF THE EXEMPLARY EMBODIMENTS

Reference will now be made in detail to certain embodiments of the invention, examples of which are illustrated in the accompanying drawings. While the invention will be described in reference to these embodiments, it will be understood that they are not intended to limit the invention. Conversely, the invention is intended to cover alternatives, modifications, and equivalents that are included within the scope of the invention as defined by the claims. In the following disclosure, specific details are given as a way to provide a thorough understanding of the invention. However, it will be apparent to one skilled in the art that the present invention may be practiced without these specific details.

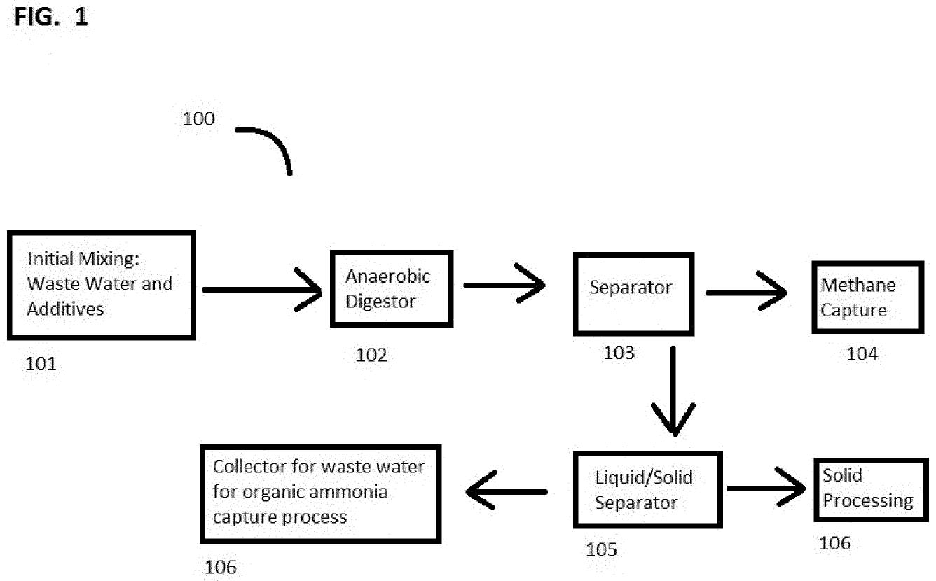

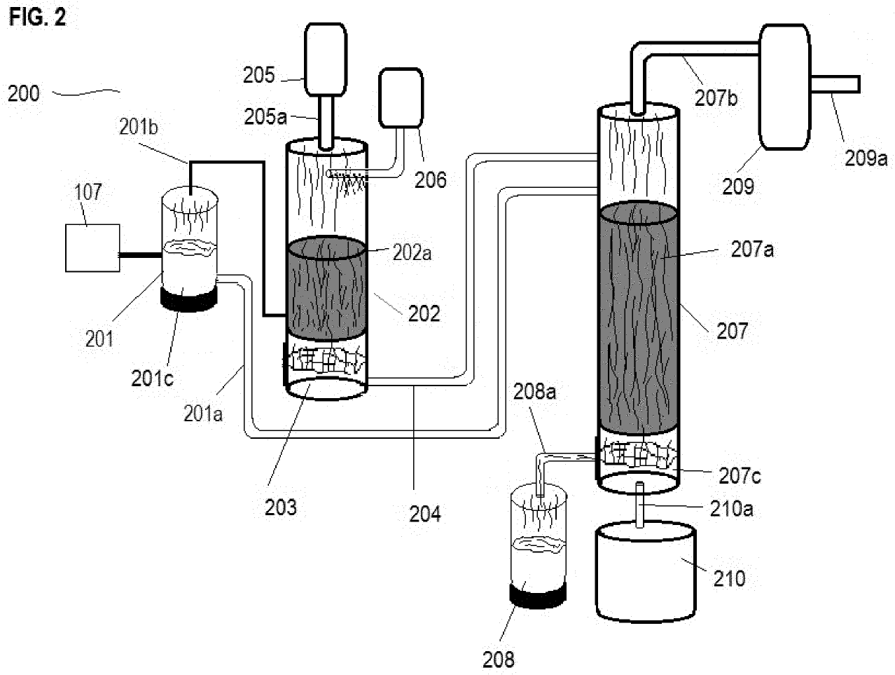

Referring to the drawings, wherein like reference characters designate like or corresponding parts throughout the several views, and referring particularly to FIGS. 1-2, it is seen that the present invention includes various embodiments of organic fertilizers containing organically produced ammonia, and methods of production of such fertilizers.

Methods of Producing Organic Ammonia Fertilizers

As seen in FIG. 1, the present invention may include a process for extracting a nitrogen rich effluent from an unrefined waste, or discarded organic material, source such as manure, food waste, municipal sewage, or other sources of natural nitrogenous material. FIG. 1 provides a generalized visual overview of the effluent processing steps. The discarded organic material may be introduced into a first mixing tank 101, which may be a large basin or vat able to receive large volumes of organic material. For example, the tank 101 may hold a volume of organic material in a range of about 5,000 gallons to about 500,000 gallons. The tank 101 may have an agitation mechanism for mixing the organic material and any additional additives into a substantially uniform, but heterogeneous mixture to avoid stratification of the mixture. For example, the mixing tank may include a central vertical agitator, a stirring rod, water injectors, recirculation pumps, or other agitation mechanism.

The additives for improving the anaerobic digestion and nitrogen content of the resulting digested mixture may be added into the mixing tank 101. Such additives may include blood meal, sweet clover, and other nutrients such as sodium, calcium, magnesium. Trace amounts of elements such as nickel, cobalt, molybdenum, and selenium, which may acts as cofactors of anaerobic metabolic enzymes may be added as well.

After the effluent has been sufficiently mixed with the additives, the effluent mixture may be transferred to an anaerobic digester 102 in which anaerobic bacteria break down nitrogenous compounds to form natural, organic ammonia and nitrates. The anaerobic digester may be a closed vessel, from which oxygen is substantially removed. The anaerobic digester 102 may be a sealed anaerobic lagoon digester, a plug flow digester (a long, narrow concrete tank); complete mix digester (an enclosed, heated tank with a mechanical, hydraulic, or gas mixing system); a dry digestion digester (an upright, silo-style digester made of concrete and steel), or other type of anaerobic digester. In the anaerobic digester, anaerobes hydrolyze the complex organic material (e.g., carbohydrates and polypeptides) in the effluent mixture under anaerobic conditions, resulting in simpler organic molecules (e.g., the sugars and amino acids). Additional bacteria (e.g., acidogenic bacteria) may then catabolize the simpler organic molecules to form carbon dioxide, hydrogen, ammonia, and organic acids. Acetogenic bacteria may convert the organic acids into acetic acid, along with additional ammonia, hydrogen, and carbon dioxide. In some embodiments, methanogens may be present to convert these products to methane and carbon dioxide.

The mixing tank 101 and the anaerobic digester 102 may be connected via pipeline, allowing the effluent mixture to flow by pump or gravity from mixing tank 101 to the digester 102. Once the waste water mixture is delivered into the anaerobic digester 102, it may be agitated by an agitation mechanism such as a central vertical agitator, a stirring rod, water jets or effluent recirculation to create circulation, or other agitation mechanism. The effluent mixture is continuously stirred during the digestion period, which may be in the range of about 1 to about 30 days while maintained at a temperature in a range of about 70° F. and about 115° F. (e.g., about 80° F. to about 105° F., or any value or range of values therein). This temperature range is ideal for the anaerobic bacteria present in the digester and maximizes the metabolic activity thereof. Biogas, including methane and carbon dioxide, and nitrogenous compounds, including ammonia and nitrates are produced and dissolved in the digested effluent product.

After the digestion period, the biogas produced during the may be siphoned off of the digested mixture and collected in a biogas separator 103. The biogas may be subsequently processed through a methane capture process 104, which may include a scrubbing process to remove contaminating gases such as CO₂ and H₂S. The biogas separator may simply include the periodic or continuous application of a partial vacuum to the digester 102 to remove the gas produced by the digesting process. In other examples, the digested effluent and biogas may be transported to a separator chamber, such as a cyclonic chamber or centrifuge to separate the phases of the digested material into solids, liquids, and biogas. The biogas may be removed by vacuum, and the effluent may then be collected and transported to a liquid/solid separator 105.

The liquid/solid separator 106 allows the ammonia and nitrate rich liquid effluent from the digester to be isolated for further processing. The liquid/solid separator 105 may be a settling tank that allows the solid to settle to the bottom and yielding a separate liquid fraction that can be removed from the top by a pump through a filtered outlet. In other examples, the liquid/solid separator 105 may be a screw press that captures the solids in the effluent and allows the liquid phase to be separately captured. In still other examples, the liquid/solid separator 105 may be a dewatering centrifuge, able to separate and collect the liquid phase of the biodigester effluent. The liquid phase may be then transferred to a collector 107 for an organic ammonia capture process. The solid portion of the effluent may be used in a separate drying and stabilization processing 106 to produce a solid nitrogen fertilizer.

The liquid phase may be transferred from the collector 107 to a column separation apparatus 200 to purify and capture the ammonia from the liquid phase. The apparatus 200 is shown in FIG. 2, and includes several components. The liquid phase may first be transferred to a heating chamber 201 in which the liquid phase effluent may be heated to a temperature in a range of about 120° F. to about 150° F. to drive CO₂ out of the liquid phase effluent. The heating process may remove up to about 90% of the CO₂ from the liquid phase, thereby pushing the chemical equilibrium of ammonium bicarbonate and ammonia significantly toward free ammonia, thereby facilitating an extraction of a greater quantity of ammonia from the liquid phase in subsequent steps. Ammonia largely remains in the liquid phase as bound ammonium compounds and ammonia. However, there may be a significant amount NH₃ gas evolved from the effluent.

The ammonium-rich liquid phase effluent 201c may then be transferred to a packed column 207 by a conduit 201a. The evolved gas from the heating chamber 201 may be transferred via conduit 201b to a separate interim packed column 202 that may be designed to recapture the NH₃ gas in the evolved gas and thereby recapture the desired NH₃ and separate and dispose of the CO₂ gas. The packed column 202 may contain a conventional, high surface area packing material 202a as a stationary phase. The packed material may be a corrosion-resistant, high surface area arrangement of metal or plastic grates or other high surface area structures to thoroughly mix the liquid and gases present in the column. A cooling fluid (e.g., water) from a fluid source 206 may be provided in the upper portion of the column 202 (e.g., by spraying through a spraying bar) in order to lower the temperature of the evolved gas such that the NH₃ vapor is condensed and dissolved in the aqueous effluent phase, while all or nearly all of the CO₂ remains as gas. The cooling fluid may lower the temperature within the column to about 100° F. or less (e.g., in a range of about 60° F. to about 100° F., or more particularly in a range of about 70° F. to about 90° F.), allowing a large majority of the ammonia to be dissolved in water or aqueous fluid in the column 202. The lower the pH and temperature, the more ammonia can be reabsorbed (dissolved) in an aqueous fluid. For example, at a pH of 8.5 or less and a temperature of about 85° F. or less, more than 75% of ammonia in a closed system is in the dissolved, ionized ammonium NH₄⁻ form.

The evolved gas may be transferred directly into the packed material 202 by conduit 201b in order to facilitate mixing and high surface area interaction of the evolved gas and the cooling fluid. The CO₂ gas may rise and escape through a conduit in the upper section 202a to a CO₂ exhaust and scrubbing system 205. A partial vacuum may be applied to the conduit 205a to assist in removing the CO₂ gas. The NH₃ vapor is largely recaptured in the cooling fluid and collected in solution 203 at the bottom of the column 202.

The solution 203 can then be transferred to the packed column 207 by conduit 204. The conduit 204 delivers the solution 203 to the upper portion of the column 207 above packed material 207a positioned in the column 207. As previously mentioned, the effluent fluid 201c from the heating chamber 201 is also delivered to the upper portion of column 207 by conduit 201a. Thus, the NH₃ collected from both the liquid effluent 201c and the evolved gas are combined in the packed column 207 to separate NH₃ out of the liquid phase solutions 201c and 203.

As in the column 202, the packed material in the column 207 may be a corrosion-resistant, high surface area arrangement of metal or plastic grates or other high surface area structures. In order to maintain a high temperature of the liquid effluent 201c and the solution 203 as they pass through the packed material and promote the volatilization of the ammonia therein, steam may be provided to the bottom of the column 207 from a boiler 208 via line 208a. The high surface area packing material 207a may allow for high surface area interaction between the steam and the fluids 201c and 203 to allow for the collection of the volatilized ammonia. The steam/ammonia mixture may rise through the column 207 and collected by a conduit 207b that transfers the steam/ammonia mixture to a condenser 209 for cooling and collection. The steam/ammonia mixture condenses to form an aqueous ammonia solution that has a concentration in the range of 10% NH₃ w/w to about 25% NH₃ w/w. The concentrated aqueous ammonia solution is drained from the condenser 209 via collection conduit 209a and collected.

The liquid phase effluent 207c that remains after the steam scrubbing process runs to the bottom of the column 207 and collects in the bottom thereof. A waste conduit 210a may transfer the liquid phase effluent 207c to a waste processing unit 210. The liquid phase effluent 207c that drains from the column 207 is substantially free of ammonia, and thus has significantly reduced toxicity.

In some embodiments, the concentrated aqueous ammonia solution may be further concentrated by returning the solution to stripping column 207 to be steam stripped a second time. In such embodiments, the concentration of the double-steam-stripped aqueous ammonia may be in the range of about 15% NH₃ to about 30% NH₃ by weight. In still further embodiments, the concentration of ammonia in the captured aqueous ammonia solution may be increased to a concentration in a range of 25% NH₃ to about 35% NH₃ by weight by pressurizing the stripping column 207. The steam stripping column pressure may be increased by pumping steam into the stripping column from the boiler 208. The stripping column 207 may be pressurized to an internal pressure of about 2.5 atm to about 4 atm. In such embodiments, the pressure inside the stripping column 207 may be maintained by check valves (or other valve mechanisms) placed in the conduits 204, 207b, and 210a. The condenser may then drop the temperature of the steam/ammonia solution to a temperature of below about 55° C. (e.g., a temperature in a range of about 40° C. to about 50° C.) in order to keep the ammonia in solution at a higher concentration of 25% NH₃ w/w to about 35% NH₃ w/w at ambient pressure. Alternatively, the aqueous ammonia solution yielded in the condenser 209 can be maintained under higher pressure (e.g., about 2 atm to about 3 atm) and/or low temperature (e.g., about 40° C. to about 60° C.) in order to keep the ammonia in solution at higher concentration.

In still further embodiments, the ammonia solution produced by the foregoing steps may also be further concentrated by the further step of adding a basic agent (e.g., NaOH) and heating the resulting ammonium hydroxide solution and vacuuming off the evolved NH₃ gas into an extremely low-temperature condenser operable to cool the liquid to at least −28° F. to capture the NH₃ gas as a liquid at high concentration. Such NH₃ product may have concentrations of greater than 35% w/w of ammonia up to substantially anhydrous NH₃ liquid.

Organic Ammonia Fertilizers

The organic ammonia and other nitrogenous compounds produced by the foregoing methods can be included in organic fertilizers that are compliant with NOP and other agency standards for use in organic farming. The ammonia produced by the foregoing methods may be mixed with various additional organic-compliant ingredients to produce a balanced organic ammonia fertilizer.

The organic fertilizers of the present invention may be liquid fertilizers that include a concentration of organic ammonia in a range of 10% by weight to about 25% by weight. The fertilizers may further include organic acids that may serve to balance the pH effects of the concentrated ammonia in the fertilizer. The pH may be maintained in a range around neutral pH, such as between about pH 6 and pH 7 (e.g., from about pH 6.5 to about pH 7.5). To balance the pH of the liquid fertilizer, the liquid fertilizer may include one or more organic acids.

The organic fertilizers may include one or more weak organic acids or salts thereof (e.g., polyprotic organic acids or salts thereof), such as citric acid, malic acid, fumaric acid, salts of such organic acids, and combinations thereof. Other simpler organic acids, such as acetic acid salts of such organic acids may be used as well. The organic acids must be from organically-compliant sources (e.g., OMRI compliant) Citric acid may be preferred due to its tri-protic chemistry and superior buffering capabilities. The organic acid(s) may be present in a concentration in the liquid fertilizer in a range of about 15% by weight to about 50% by weight, depending on the concentration of ammonia in the liquid fertilizer. For example, the concentration of citric acid in the liquid fertilizer by weight may be about twice the amount of ammonia present in the solution by weight. In such examples, if the concentration of organic ammonia in the liquid fertilizer is 10% by weight, the concentration of citric acid may be about 20% by weight. Simpler monoprotic acids may be present in higher concentrations, due to their lower buffering capacity.

The organic fertilizers of the present invention may also include humic acid which helps with nitrogen fixation in the organic fertilizers. Liquid ammonia fertilizers suffer from nitrogen loss through the evaporation or other pathways of loss. Planting soils are typically acidic to optimize conditions for the growth of plants, which exhibit optimal germination and growth in a pH range of about pH 5.5 to about pH 7.0. The acidic pH of the soil can drive ammonia volatilization. This particularly significant where the fertilizer composition has a relatively high nitrogen concentration (e.g., greater than 10% w/w), since the higher concentration results in a higher rate of volatilization.

Humic acids are able to retain NH₄ as well as aid in NH₃ ammonia volatilization reduction. Humic acids have high cation exchange capacity (CEC) that allows it to retain soil cations and can significantly reduce NH₃ volatilization upon addition to an acid soil (e.g., through the addition of peat). The addition of humic acids to the organic NH₃ fertilizer of the present invention significantly reduces NH₃ volatilization and lead to effective accumulation of NH₄ in the planting soil, despite having an acidic pH (e.g., about pH 5.5 to about 7.0). The humic acids may provide the additional benefit of providing short carbon-chain molecules

Humic acids may be added included in the organic fertilizer composition of the present invention in a concentration in a range of about 3% w/w to about 8% w/w. The amount of humic acids included in the organic fertilizer may vary with the concentration of ammonia provided therein. For example, in compositions comprising about 10% to about 15% NH₃ w/w, the fertilizer composition may include about 3% to about 4% w/w of humic acids. In compositions comprising about 15% to about 25% organic NH₃ w/w, the fertilizer composition may include about 5% to about 8% w/w of humic acids.

The organic fertilizer composition of the present invention may also include additional components routinely used in the art, for example, humectants, adjuvants, antioxidants, stabilizers, plant macronutrients, plant micronutrients, and combinations thereof.

### CONCLUSION/SUMMARY

The present invention provides organic ammonia fertilizer compositions and methods of making the same. It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. (canceled)

2. (canceled)

3. (canceled)

4. (canceled)

5. (canceled)

5. (canceled)

7. (canceled)

8. (canceled)

9. (canceled)

9. (canceled)

11. (canceled)

12. A method of producing organic ammonia, comprising:
a. heating an organic waste material in an anaerobic digester device to drive a biological anaerobic digestion of the organic waste material and yield a digested organic waste composition;
b. separating solid portions of the organic waste composition from an effluent of the digested organic waste composition;
c. heating said effluent to evolve CO₂-laden gas from the effluent;
d. transferring the heated effluent to a steam stripping apparatus to extract NH₃ from said heated effluent in a steam/NH₃ solution; and
e. condensing the steam/NH₃ solution to yield an aqueous NH₃ product derived from effluent without chemical reactions.

13. The method of claim 12, wherein said step of heating said effluent drives the chemical equilibrium of ammonium bicarbonate toward the production of NH₃ and CO₂.

14. The method of claim 12, further comprising adding a basic chemical agent to the effluent before or during the step of heating said effluent to increase the pH of the effluent.

12. The method of claim 12, further comprising the step of transferring the CO₂-laden gas to a packed column to cool the CO₂-laden gas and dissolve NH₃ present in the gas in a cooling fluid.

16. The method of claim 15, further comprising transferring the cooling fluid and NH₃ dissolved therein to the steam stripping process to extract the dissolved NH₃.

17. A liquid organic nitrogenous fertilizer composition, comprising:
a. an aqueous solution of
i. the aqueous NH₃ product of any of claims 12-16; and
ii. an organic acid in a concentration of about 6% to about 50%.

18. (canceled)

19. (canceled)

20. (canceled)

21. (canceled)

22. (canceled)

23. (canceled)

24. The composition of claim 17, wherein the concentration of organically produced ammonia is in a concentration of about 10% w/w to about 20% w/w.

25. (canceled)

25. (canceled)

27. (canceled)

28. A method of producing organic ammonia, comprising:
a. heating a nitrogen-rich effluent to evolve CO₂-laden gas from the effluent;
b. transferring the heated effluent to a steam stripping process to extract NH₃ from said heated effluent in a steam/NH₃ solution; and
c. condensing the steam/NH₃ solution to yield an aqueous NH₃ product derived from said effluent without utilizing chemical reactions.

29. The method of claim 28, wherein said step of heating said effluent drives the chemical equilibrium of ammonium bicarbonate toward the production of NH₃ and CO₂.

30. The method of claim 28, further comprising adding a basic chemical agent to the effluent before or during the step of heating said effluent to increase the pH of the effluent.

31. The method of claim 28, further comprising the step of transferring the CO₂-laden gas to a packed column to cool the CO₂-laden gas and dissolve NH₃ present in the gas in a cooling fluid.

32. The method of claim 31, further comprising transferring the cooling fluid and NH₃ dissolved therein to the steam stripping process to extract the dissolved NH₃.

33. A liquid organic nitrogenous fertilizer composition, comprising:
a. an aqueous solution of
i. the aqueous NH₃ product of any of claims 28-32; and
ii. an organic acid in a concentration of about 6% to about 50%.

34. (canceled)

35. (canceled)

36. The composition of claim 33, wherein the concentration of organically produced ammonia is in a concentration of about 10% w/w to about 20% % w/w.

37. (canceled)

38. (canceled)

39. (canceled)

40. (canceled)

41. (canceled)

42. (canceled)

43. (canceled)

44. A liquid organic nitrogenous fertilizer composition, comprising:
an aqueous solution including a biologically produced ammonia in a concentration of about 3% to about 25%.

45. The composition of claim 44, further comprising humic acids as a chelation agent for the ammonia.

44. The composition of claim 44, wherein said humic acids is present in a concentration of about 3% to about 8%.

47. The composition of claim 45, wherein the concentration of organically produced ammonia is in a concentration of about 10% w/w to about 20% w/w.

48. The composition of claim 44, further comprising an organic acid.

49. The composition of claim 48, wherein said organic acid is a triprotic acid.

50. (canceled)

51. (canceled)
